(19) United States
(12) Patent Application Publication
(10) Pub. No.: US 2017/0053261 A1
(43) Pub. Date: Feb. 23, 2017

(54) APPARATUS AND METHOD FOR HOW TO DELIVER BIN RANGES TO DEVICE WITHOUT INCURRING NETWORK LATENCY AND COST WITH HASH-BASED MECHANISM

(71) Applicant: Samsung Electronics Co., Ltd., Suwon-si (KR)

(72) Inventors: Shahab MOHSEN, Mountain View, CA (US); Aneesh NAINAMVALAPPIL, Mountain View, CA (US); Minseok PARK, Mountain View, CA (US); Chung LIU, Mountain View, CA (US)

(21) Appl. No.: 15/217,382

(22) Filed: Jul. 22, 2016

Related U.S. Application Data
(60) Provisional application No. 62/208,276, filed on Aug. 21, 2015.

(51) Int. Cl. G06Q 20/32; G06Q 20/38; G06Q 20/40; G06Q 20/10

(52) U.S. Cl. CPC G06Q 20/3221; G06Q 20/108; G06Q 20/3827; G06Q 20/409

(57) ABSTRACT

An apparatus and method for confirming bank information on a mobile device are provided. The method includes transmitting, to a payment server, a transactional message of a payment system, the transactional message including an identifier of the bank information, and receiving, when it is determined that the identifier of the bank information is no longer valid, a plurality of bank information.

### CROSS-REFERENCE TO RELATED APPLICATION(S)

This application claims the benefit under 35 U.S.C. §119(e) of a U.S. Provisional application filed on Aug. 21, 2015 in the U.S. Patent and Trademark Office and assigned Ser. No. 62/208,276, the entire disclosure of which is hereby incorporated by reference.

### TECHNICAL FIELD

The present disclosure relates to an apparatus and method for providing a mobile device using a payment application, bank identification number (BIN) ranges prior to verifying a bank card number by the payment application. More particularly, the present disclosure relates to an apparatus and method for determining whether the BIN ranges stored on a mobile device are valid prior to the payment application attempting to verify the bank card by identifying the BIN ranges in each transaction with a server payment application.

### BACKGROUND

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MIMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

One such function is a payment application such as Samsung Pay™, Android Pay™, Apple Pay™, and the like. These functions allow a user to make a purchase at a point of sale terminal using an electronic device rather than a traditional bank card with a magnetic strip which is read by a reader on the point of sale terminal.

Prior to using the payment application, the user associates an account of the payment application with at least one of a plurality of bank cards. Such bank cards are issued by VISA™, Master Card™, AIVIEX™ and private label credit cards. Each of these bank cards has a bank identification number (BIN). All the currently know BINs that are available to the payment application are stored on the electronic device. A problem occurs in how to confirm that the BINs currently stored on an electronic device are valid when a user adds a first or additional bank card to his or her account.

Accordingly, there is a need for an apparatus and method for providing BIN ranges to an electronic device without incurring network latency.

### SUMMARY

Aspects of the present disclosure are to address at least the above-mentioned problems and/or disadvantages and to provide at least the advantages described below. Accordingly, an aspect of the present disclosure is to provide an apparatus and method for providing BIN ranges to an electronic device without incurring network latency.

In accordance with an aspect of the present disclosure, a method for confirming bank information on a mobile device is provided. The method includes transmitting, to a payment server, a transactional message of a payment system, the transactional message including an identifier of the bank information, and receiving, when it is determined that the identifier of the bank information is no longer valid, a plurality of bank information.

In accordance with another aspect of the present disclosure, an electronic device for confirming bank information in a payment system is provided. The electronic device includes a memory configured to store data and executable instructions, a transceiver configured to transmit and receive the data, and a processor configured by the executable instructions to control to transmit, to a payment server, a transactional message of a payment system, the transactional message including an identifier of the bank information, and control to receive, when it is determined that the identifier of the bank information is no longer valid, a plurality of bank information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of various embodiments of the present disclosure will be more apparent from the following description taken in conjunction with the accompanying drawings, in which:

FIG. 1 is a block diagram illustrating an electronic device in a network environment according to an embodiment of the present disclosure;

FIG. 2 is a block diagram illustrating an electronic device according to an embodiment of the present disclosure;

FIG. 3 is a view of a payment system in a network environment according to an embodiment of the present disclosure;

FIG. 4 is a system diagram illustrating updating bank identification numbers of an electronic device according to an embodiment of the present disclosure;

FIG. 5 is a system diagram illustrating adding a bank card to a payment application of an electronic device according to an embodiment of the present disclosure;

FIG. 6 illustrates transformation of bank identification to a hash value according to an embodiment of the disclosure; and

FIG. 7 is a flowchart of a method of confirming BIN ranges in an electronic device according to an embodiment of the present disclosure.

Throughout the drawings, it should be noted that like reference numbers are used to depict the same or similar elements, features, and structures.

### DETAILED DESCRIPTION

Detailed descriptions of various aspects of the present disclosure will be discussed below with reference to the attached drawings. The descriptions are set forth as examples only, and shall not limit the scope of the present disclosure.

The detailed description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure are provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Unless defined differently, all terms used in the present disclosure, including technical or scientific terms, have meanings that are understood generally by a person having ordinary skill in the art. Ordinary terms that may be defined in a dictionary should be understood to have the meaning consistent with their context, and unless clearly defined in the present disclosure, should not be interpreted to be excessively idealistic or formalistic.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an MP3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a digital video disk (DVD) player, an audio player, a refrigerator, an air conditioner, a vacuum cleaner, an oven, a microwave oven, a washer, a dryer, an air purifier, a set-top box, a TV box (e.g., Samsung HomeSync™, Apple TV, or Google TV™), a gaming console, an electronic dictionary, an electronic key, a camcorder, an electronic picture frame, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

Various embodiments of the present disclosure include an apparatus and method for delivering BIN ranges to an electronic device without incurring network latency during a bank card verification procedure.

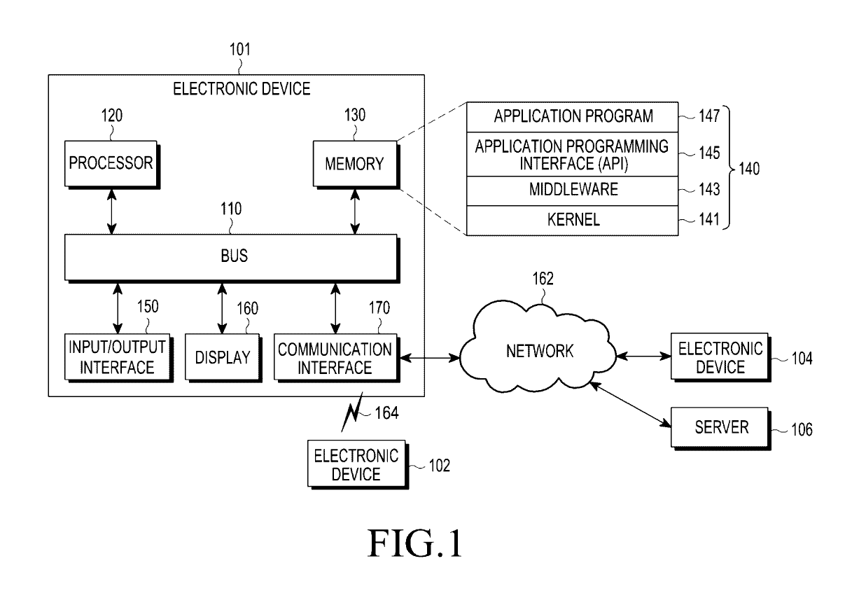

FIG. 1 is a block diagram illustrating an electronic device in a network environment according to an embodiment of the present disclosure.

Referring to FIG. 1, an electronic device 101 may include a bus 110, a processor 120, a memory 130, an input/output interface 150, a display 160, and a communication interface 170. In some embodiments of the present disclosure, the electronic device 101 may exclude at least one of the components or may add another component.

The bus 110 may include a circuit for connecting the components with one another and transferring communications (e.g., control messages and/or data) between the components.

The processor 120 may include one or more of a CPU, an AP, and a communication processor (CP). The processor 120 may perform control on at least one of the other components of the electronic device 101, and/or perform an operation or data processing relating to communication.

The memory 130 may include a volatile and/or non-volatile memory. For example, the memory 130 may store commands or data related to at least one other component of the electronic device 101. According to an embodiment of the present disclosure, the memory 130 may store software and/or a program 140. The program 140 may include, e.g., a kernel 141, middleware 143, an application programming interface (API) 145, and/or an application program 147 (or “application”). At least a portion of the kernel 141, middleware 143, or API 145 may be denoted an operating system (OS).

For example, the kernel 141 may control or manage system resources (e.g., the bus 110, processor 120, or memory 130) used to perform operations or functions implemented in other programs (e.g., the middleware 143, API 145, or application 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example.

Further, the middleware 143 may process one or more task requests received from the application 147 in order of priority. For example, the middleware 143 may assign at least one application 147 with priority of using system resources (e.g., the bus 110, processor 120, or memory 130) of at least one electronic device 101. For example, the middleware 143 may perform scheduling or load balancing on the one or more task requests by processing the one or more task requests according to the priority assigned to the at least one application 147.

The API 145 may be an interface allowing the application 147 to control functions provided from the kernel 141 or the middleware 143. For example, the API 145 may include at least one interface or function (e.g., a command) for filing control, window control, image processing or text control.

The input/output interface 150 may serve as an interface that may, e.g., transfer commands or data input from a user or other external devices to other component(s) of the electronic device 101. Further, the input/output interface 150 may output commands or data received from other component(s) of the electronic device 101 to the user or the other external device.

The display 160 may include, e.g., a liquid crystal display (LCD), a light emitting diode (LED) display, an organic LED (OLED) display, a microelectromechanical systems (MEMS) display, or an electronic paper display. The display 160 may display, e.g., various contents (e.g., one or more of text, images, videos, icons, and symbols) to the user. The display 160 may include a touchscreen and may receive, e.g., a touch, gesture, proximity or hovering input using an electronic pen or a body portion of the user.

For example, the communication interface 170 may set up communication between the electronic device 101 and an external electronic device (e.g., a first external electronic device 102, a second external electronic device 104, or a server 106). For example, the communication interface 170 may be connected with a network 162 through wireless or wired communication to communicate with the external electronic device.

The wireless communication may be a cellular communication protocol and may use at least one of, e.g., long-term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM). Further, the wireless communication may include, e.g., short-range communication 164. The short-range communication 164 may include at least one of Wi-Fi, Bluetooth (BT), near-field communication (NFC), or GNSS. The GNSS may include at least one of, e.g., global positioning system (GPS), global orbiting navigation satellite system (GLONASS), Beidou navigation satellite system (hereinafter, “Beidou”) and Galileo, or the European global satellite-based navigation system. Hereinafter, the terms “GPS” and “GNSS” may be used interchangeably. The wired connection may include at least one of a universal serial bus (USB), high definition multimedia interface (HDMI), recommended standard 232 (RS-232), or plain old telephone service (POTS). The network 162 may include at least one of telecommunication networks, e.g., a computer network (e.g., local area network (LAN) or wide area network (WAN)), Internet, or a telephone network.

The first and second external electronic devices 102 and 104 each may be a device of the same or a different type from the electronic device 101. According to an embodiment of the present disclosure, the server 106 may include a group of one or more servers. According to an embodiment of the present disclosure, all or some of operations executed on the electronic device 101 may be executed on another or multiple other electronic devices (e.g., the external electronic devices 102 and 104 or server 106). According to an embodiment of the present disclosure, when the electronic device 101 should perform some function or service automatically or at a request, the electronic device 101, instead of executing the function or service on its own or additionally, may request another device (e.g., external electronic devices 102 and 104 or server 106) to perform at least some functions associated therewith. The other electronic device (e.g., external electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

According to an embodiment of the present disclosure, the processor 120 may include an AP as a main processor, which is a high-power processor that includes a high-performance CPU performing user interfaces (UIs) and complicated computations and a high-capability memory, and a supplementary processor (SP), which may be a low-power processor having a low-performance CPU and a low-capability memory as compared with the AP. According to an embodiment of the present disclosure, a first processor may include the SP, a sub processor, or a low-power processor, and a second processor may include the AP, a main processor, or a high-power processor. The AP may process at least part of information obtained from other elements (e.g., at least one of the SP, the memory 130, the input/output interface 150, or the communication interface 170) and may use the same in various manners. For example, the AP may control at least some functions of the electronic device 101 so that the electronic device 101 may interwork with another electronic device (e.g., the external electronic device 102 or 104 or the server 106). The AP may be integrated with the processor 120 or the communication interface 170. According to an embodiment of the present disclosure, at least one configuration of the AP may be included in the server 106 and may be supported for at least one operation implemented on the AP from the server 106. Here, the AP may have the same configuration as the processor 120, and the AP may be denoted as a “main processor,” “central processing apparatus,” “CPU,” “high-power processor,” “high-specification processor,” or “AP.”

The SP may be included in the processor 120 and may be a processor provided separately from the AP and optimized for low-power operations, and the SP may have a lower computational capability and further restricted interfaces and memories as compared with the AP to enable continuous operation with relatively minimized power consumption. The SP may interwork with, e.g., at least one sensor (e.g., an acceleration sensor, gyro sensor, or geo-magnetic sensor) to collect sensing data and may use the collected sensing data to produce context data representing the user's motion state (e.g., sitting, standing, walking, running, biking, or driving), a moving speed or a moving direction. Further, the SP may interwork with at least one communication module (e.g., a Wi-Fi module, a BT module, a GNSS module, or an NFC module) to obtain location information or discover short-range wireless signals. Here, the SP may also be denoted as a “sub processor,” “sensor hub,” “communication module,” “GPS module,” “micro controller,” “sensing processor,” or “SP.”

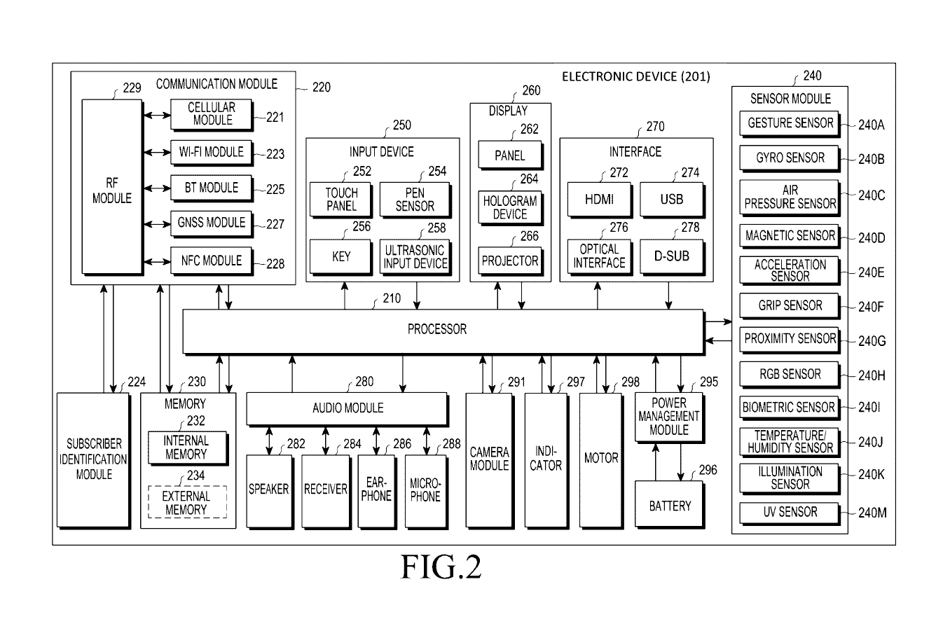

FIG. 2 is a block diagram illustrating an electronic device according to an embodiment of the present disclosure.

Referring to FIG. 2, an electronic device 201 may include the whole or part of the configuration of, e.g., the electronic device 101 shown in FIG. 1. The electronic device 201 may include one or more processors (e.g., APs) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control multiple hardware and software components connected to the processor 210 by running, e.g., an OS or application programs, and the processor 210 may process and compute various data. The processor 210 may be implemented in, e.g., a system on chip (SoC). According to an embodiment of the present disclosure, the processor 210 may further include a graphic processing unit (GPU) and/or an image signal processor (ISP). The processor 210 may include at least some (e.g., cellular module 221) of the components shown in FIG. 2. The processor 210 may load a command or data received from at least one of other components (e.g., a non-volatile memory) on a volatile memory, processor the command or data, and store various data in the non-volatile memory.

The communication module 220 may have the same or similar configuration to the communication interface 170 of FIG. 1. The communication module 220 may include, e.g., cellular module 221, a Wi-Fi module 223, a BT module 225, a GNSS module 227, a NFC module 228, and a radio frequency (RF) module 229.

The cellular module 221 may provide voice call, video call, text, or Internet services through, e.g., a communication network. The cellular module 221 may perform identification or authentication on the electronic device 201 in the communication network using a SIM 224 (e.g., the SIM card). According to an embodiment of the present disclosure, the cellular module 221 may perform at least some of the functions provided by the processor 210. According to an embodiment of the present disclosure, the cellular module 221 may include a CP.

The Wi-Fi module 223, the BT module 225, the GNSS module 227, or the NFC module 228 may include a process for, e.g., processing data communicated through the module. At least some (e.g., two or more) of the cellular module 221, the Wi-Fi module 223, the BT module 225, the GNSS module 227, and the NFC module 228 may be included in a single integrated circuit (IC) or an IC package.

The RF module 229 may communicate data, e.g., communication signals (e.g., RF signals). The RF module 229 may include, e.g., a transceiver, a power amplifier module (PAM), a frequency filter, a low noise amplifier (LNA), or an antenna. According to an embodiment of the present disclosure, at least one of the cellular module 221, the Wi-Fi module 223, the BT module 225, the GNSS module 227, and the NFC module 228 may communicate RF signals through a separate RF module.

The SIM 224 may include, e.g., a card including a SIM and/or an embedded SIM, and may contain unique identification information (e.g., an integrated circuit card identifier (ICCID) or subscriber information (e.g., an international mobile subscriber identity (IMSI)).

The memory 230 (e.g., the memory 130) may include, e.g., an internal memory 232 or an external memory 234. The internal memory 232 may include at least one of, e.g., a volatile memory (e.g., a dynamic random access memory (DRAM), a static RAM (SRAM), a synchronous DRAM (SDRAM), etc.) and a non-volatile memory (e.g., a one-time programmable read-only memory (OTPROM), a PROM, an erasable and programmable ROM (EPROM), an electrically EPROM (EEPROM), a mask ROM, a flash ROM, a flash memory (e.g., a NAND flash, or a NOR flash), a hard drive, or solid state drive (SSD).

The external memory 234 may include a flash drive, e.g., a compact flash (CF) memory, a secure digital (SD) memory, a micro-SD memory, a mini-SD memory, an extreme digital (xD) memory, or a memory stick. The external memory 234 may be functionally and/or physically connected with the electronic device 201 via various interfaces.

For example, the sensor module 240 may measure a physical quantity or detect a motion state of the electronic device 201, and the sensor module 240 may convert the measured or detected information into an electrical signal. The sensor module 240 may include at least one of, e.g., a gesture sensor 240A, a gyro sensor 240B, an air pressure sensor 240C, a magnetic sensor 240D, an acceleration sensor 240E, a grip sensor 240F, a proximity sensor 240G, a color sensor 240H (e.g., a red-green-blue (RGB) sensor, a biometric sensor 2401, a temperature/humidity sensor 240J, an illumination sensor 240K, and an ultra violet (UV) sensor 240M. Additionally or alternatively, the sensing module 240 may include, e.g., one of an E-nose sensor, an electromyography (EMG) sensor, an electroencephalogram (EEG) sensor, an electrocardiogram (ECG) sensor, an infrared (IR) sensor, an iris sensor, and a finger print sensor. The sensor module 240 may further include a control circuit for controlling at least one or more of the sensors included in the sensing module. According to an embodiment of the present disclosure, the electronic device 201 may further include a processor configured to control the sensor module 240 as part of an AP 210 or separately from the AP 210, and the electronic device 201 may control the sensor module 240 while the AP is in a sleep mode.

The input device 250 may include, e.g., at least one of a touch panel 252, a (digital) pen sensor 254, a key 256, and an ultrasonic input device 258. The touch panel 252 may use at least one of capacitive, resistive, infrared, and ultrasonic methods. The touch panel 252 may further include a control circuit. The touch panel 252 may further include a tactile layer and may provide a user with a tactile reaction.

The (digital) pen sensor 254 may include, e.g., a part of a touch panel or a separate sheet for recognition. The key 256 may include e.g., one of a physical button, an optical key, and a key pad. The ultrasonic input device 258 may use an input tool that generates an ultrasonic signal and enables the electronic device 201 to identify data by sensing the ultrasonic signal to a microphone (e.g., microphone 288).

The display 260 (e.g., the display 160) may include one of a panel 262, a hologram device 264, and a projector 266. The panel 262 may have the same or similar configuration to the display 160 of FIG. 1. The panel 262 may be configured to be at least one of flexible, transparent, and wearable. The panel 262 may also be incorporated with the touch panel 252 in a module. The hologram device 264 may make three dimensional (3D) images (holograms) in the air by using light interference. The projector 266 may display an image by projecting light onto a screen. The screen may be, for example, located inside or outside of the electronic device 201. In accordance with an embodiment of the present disclosure, the display 260 may further include a control circuit to control the panel 262, the hologram device 264, or the projector 266.

The interface 270 may include e.g., an HDMI 272, a USB 274, an optical interface 276, or a D-subminiature (D-sub) 278. The interface 270 may be included in e.g., the communication interface 170 shown in FIG. 1. Additionally or alternatively, the interface 270 may include a mobile high-definition Link (MHL) interface, an SD card/multimedia card (MMC) interface, or infrared data association (IrDA) standard interface.

The audio module 280 may convert a sound into an electric signal or vice versa, for example. At least a part of the audio module 280 may be included in e.g., the input/output interface 150 as shown in FIG. 1. The audio module 280 may process sound information input or output through e.g., one of a speaker 282, a receiver 284, an earphone 286, and a microphone 288.

For example, the camera module 291 may be a device for capturing still images and videos, and may include, according to an embodiment of the present disclosure, at least one of one or more image sensors (e.g., front and back sensors), a lens, an ISP, and a flash such as a LED or xenon lamp.

The power manager module 295 may manage power of the electronic device 201, for example. Although not shown, according to an embodiment of the present disclosure, the power manager module 295 may include one of a power management integrated circuit (PMIC), a charger IC, a battery gauge, and a fuel gauge. The PMIC may have a wired and/or wireless recharging scheme. The wireless charging scheme may include e.g., one of a magnetic resonance scheme, a magnetic induction scheme, and an electromagnetic wave based scheme, and an additional circuit, such as a coil loop, a resonance circuit, a rectifier, and the like may be added for wireless charging. The battery gauge may measure an amount of remaining power of at least one of the battery 296, a voltage, a current, and a temperature while the battery 296 is being charged. The battery 296 may include, e.g., one of a rechargeable battery and a solar battery.

The indicator 297 may indicate a particular state of the electronic device 201 or a part (e.g., the processor 210) of the electronic device, including e.g., at least one of a booting state, a message state, and a recharging state. The motor 298 may convert an electric signal to a mechanical vibration and may generate a vibrational or haptic effect. Although not shown, a processing unit for supporting mobile TV, such as a GPU may be included in the electronic device 201. The processing unit for supporting mobile TV may process media data conforming to a standard for digital multimedia broadcasting (DMB), digital video broadcasting (DVB), or mediaFlo™.

Each of the aforementioned components of the electronic device may include one or more parts, and a name of the part may vary with a type of the electronic device. The electronic device in accordance with various embodiments of the present disclosure may include at least one of the aforementioned components, omit some of them, or include other additional component(s). Some of the components may be combined into an entity, but the entity may perform the same functions as the components.

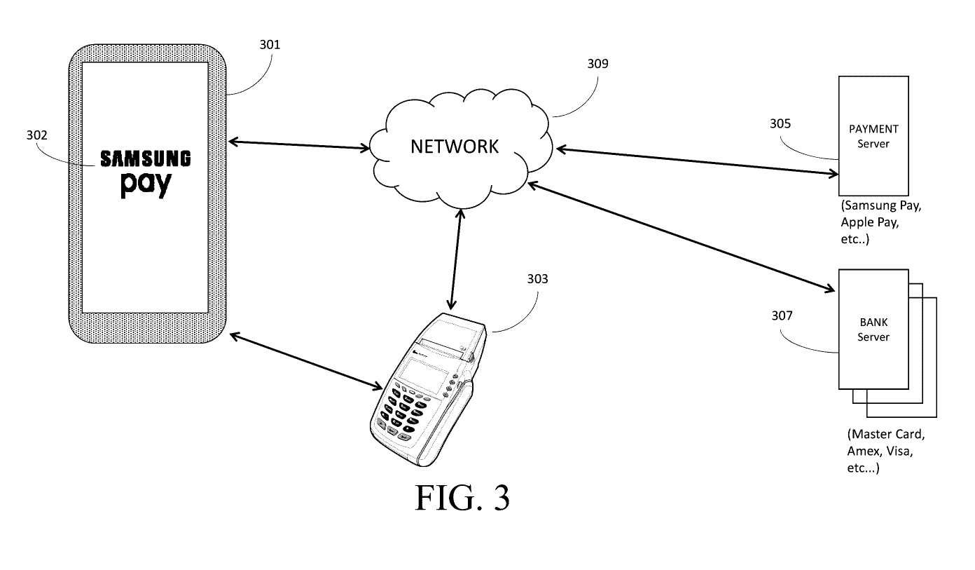

FIG. 3 is a view of a payment system in a network environment according to an embodiment of the present disclosure.

Referring to FIG. 3, an electronic device 301 of a payment application 302, such as Samsung Pay®, but is not limited thereto, is held in proximity to a point of sale terminal 303. The electronic device 301 transmits to the point of sale terminal 303 bank card information by any wireless communication, including NFC, MST and the like, or by transmission of signal read by a magnetic card reader of the point of sale terminal 303. The point of sale terminal 303 transmits the bank card information received from the electronic device 301 and sale information to the payment server 305 across a network 309. The payment server 305 validates the sale with a one of a plurality of bank servers 307 using the bank card information and sale information. The bank server 307 having validated the sale is valid using the bank card information, transmits a positive result to the payment server 305 across the network 309, which in return returns a positive result to the point of sale terminal 303.

The electronic device 301 is in communication with the payment server 305 via a cellular network or wifi network (i.e., the network 309) when not processing the bank card and the sales information via the point of sale terminal 303. Such transactions include enrolling a user into the payment system, adding a bank card to a payment system, requesting a digitized token, updating the token, making reports about the electronic device, replenishing the token, suspending the token, resuming the token, and the like.

In a header of each transaction between the electronic device 301 and the payment server 305, will be a hash representing of valid bank identification numbers (BINs). Prior to transmitting the transaction to the payment server 305, the electronic device 301 hashes, via a hash algorithm, the BINs into a single value and places that value in the header of the transaction. The electronic device 301 transmits the transaction to the payment server 305. The payment server 305 applies the same hash to the BINs stored on the payment server to produce another hash. If the hash value generated by the payment server 305 when compared with the hash value generated and transmitted by the electronic device 301 are not equal, then the payment server 305 transmits updated BINs to the electronic device 301. The electronic device 301 upon receiving the updated BINs stores the BINs. It will be understood that the electronic device 301 may create the hash value upon receiving new BINs and store that value or create the hash value prior to transmitting each transaction.

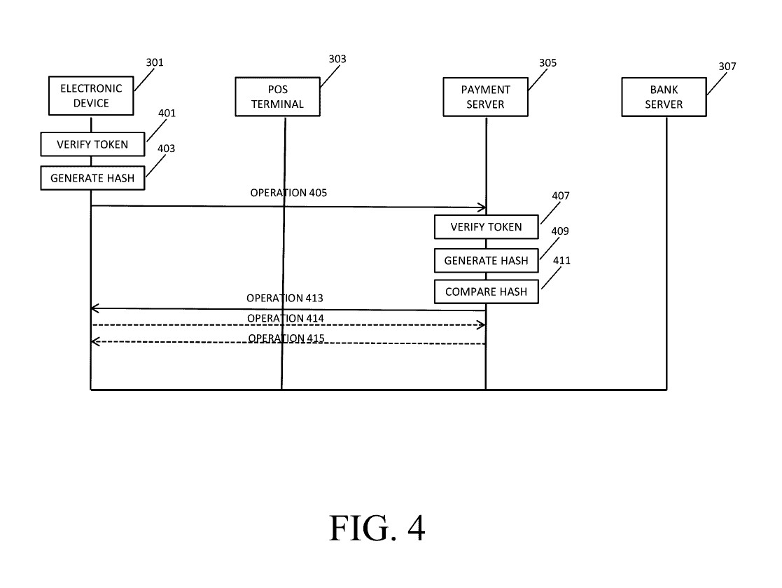

FIG. 4 is a system diagram illustrating updating bank identification numbers of an electronic according to an embodiment of the present disclosure.

Referring to FIG. 4, the electronic device 301 running a payment application, such as Samsung Pay, starts the payment application 302 and the payment application 302 having not run for a period of time determines that the payments application's token requires verification in operation 401. The payment application 302 having determined that a verification transaction is required generates a hash value for the BINs stored in the electronic device 301 in operation 403. The electronic device 301 transmits the verification transaction to the payment server 305 in operation 405.

The payment server 305 verifies the token in operation 407. Then the payment server 305 generates a hash value from the BINs stored on the payment server 305 in operation 409 and in operation 411 compares the generated value to the hash value received in operation 405.

If the payment server 305 determines that the hash values are different then the payment server 305 may transmit new BINs to the electronic device 301 in operation 413 along with the result of the verification in operation 407.

Alternatively, in operation 413 an indication that the electronic device 301 requires new BINs may be sent to the electronic device 301 along with the verification result. The electronic device 301 upon receiving the indication requests the new BINs in operation 414. The payment server 305 returns the new BINs in operation 415.

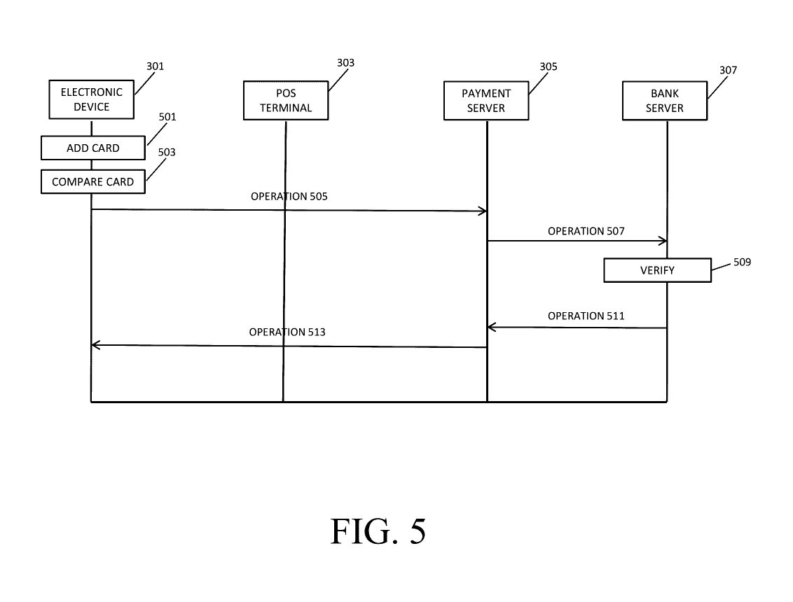

FIG. 5 is a system diagram illustrating adding a bank card to a payment application of an electronic device according to an embodiment of the present disclosure.

Referring to FIG. 5, a user of the electronic device 301 running a payment application 302 determines he or she wishes to add a bank card to their payment application account in operation 501. The payment application 302, either by photographic means or manual input (i.e., such as a keypad), enters the card information and it is compared to existing BINs stored in the electronic device. From the BINs, information such as proper expiration date format and security code formats may be extrapolated and a comparison is properly made in operation 503. If the comparison in operation 503 fails, addition of the card is rejected and an error is displayed on the display of the electronic device 301. However, if the comparison in operation 503 is successful, the electronic device 301 transmits the bank card information to the payment server 305 in operation 505. The payment server 305 in turn transmits the bank card information to the bank server 307 of the bank that issued the bank card in operation 507.

In operation 509, the bank server 307 verifies or denies the verification of the bank card. In operation 511 the bank server 307 transmits the result of the verification in operation 509 to the payment server 305. The payment server 305 in turn, transmits the verification to the electronic device 301 running the payment application 302 in operation 513.

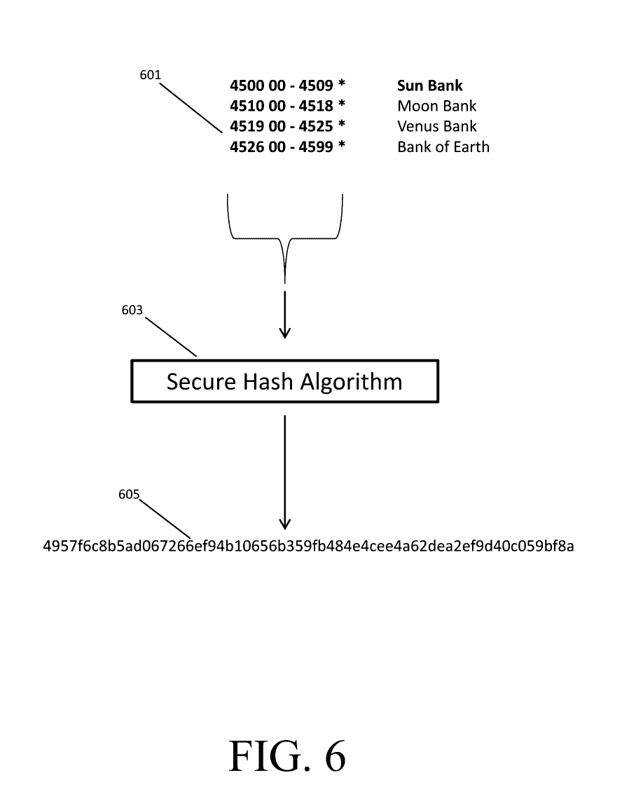

FIG. 6 illustrates transformation of bank identification to a hash value according to an embodiment of the present disclosure.

Referring to FIG. 6, BINs 601 are stored on each of the electronic device 301 and the payment server 305. Each of the electronic device 301 and payment server must create a hash value for verifying that the electronic device 301 stores the latest BINs.

The BINs are more than first 6 digits of a bank card number, and each BIN may have the following java script object notation (JSON):

```
[
  {
    “Start”: “450000”,
    “End”: “451000”,
    “TrackingData”: “01010111101010101010101111010101”,
    “DefaultAttributes”: [
      “CardNumber”,
      “Expiry”,
      “CVV”,
      “FullName”
    ]
  },
  {
    “Start”: “453000”,
    “End”: “454000”,
    “TrackingData”: “0101011111111101010101111010101”,
    “DefaultAttributes”: [
      “CardNumber”,
      “CVV”,
      “FullName”
    ]
  }
]
```

Such information allows the payment application 302 to verify that information input during the addition of a bank card is in the proper format. It also allows, in the case where the card information is manually input, to modify the user interface to receive the features in the correct format.

As can be seen above, each bank has ranges of BINs indicated by a start and end. In this manner an entry for each BIN is not required.

A secure hash algorithm (SHA) 603 is used to modify the contents of the BIN ranges into a string of a known length as identifier 605. Such a string or hash value is including in the header of each transaction made between the electronic device 301 and the payment server 305. By agreement each of the electronic device 301 and the payment server 305 apply the same algorithm.

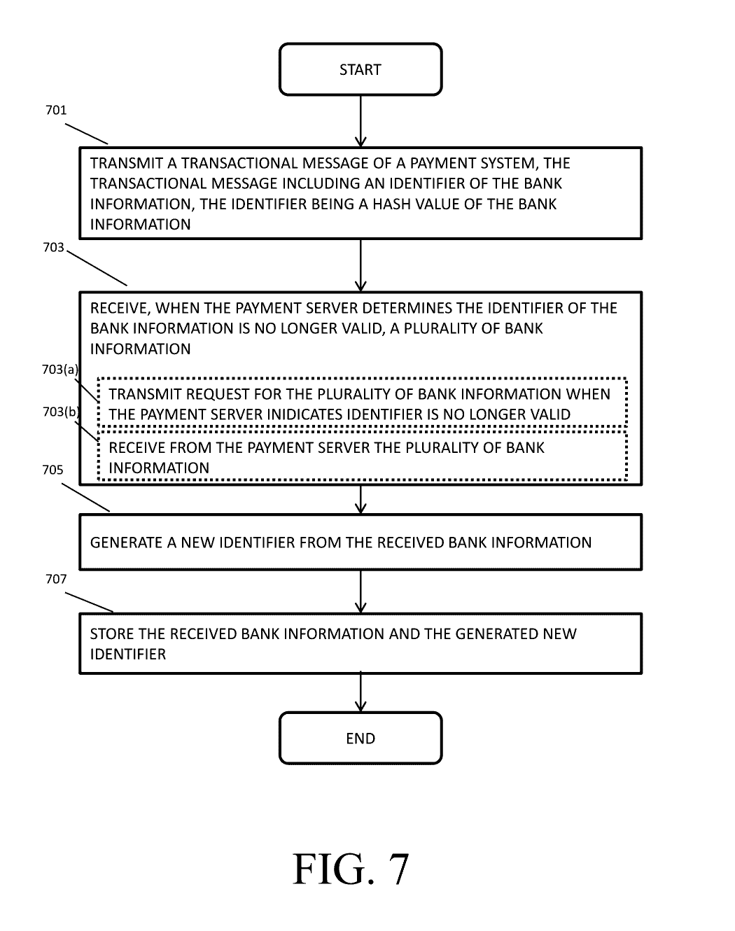

FIG. 7 is a flowchart of a method of confirming BIN ranges in an electronic device according to an embodiment of the present disclosure.

In operation 701, the electronic device 301 transmits, to a payment server 305, a transactional message of a payment system 302, the transactional message including the identifier 605 of the bank information 601. The identifier 605 is a hash value or string generated by the electronic device 301. The transactional messages include, but are not limited to, enrolling a user into the payment system, adding a bank card to a payment system, requesting a digitized token, updating the token, making reports about the electronic device, replenishing the token, suspending the token, resuming the token, and the like.

In operation 703, the electronic device 301 receives, when the payment server 305 determines the identifier of the bank information 601 is no longer valid, a plurality of updated bank information. It will be understood that the plurality of updated bank information may be returned as part of the transaction data, or alternatively, the electronic device 301 may transmit a request for the plurality of bank information to the payment server 305 in operation 703(a). In operation 703(b), the electronic device 301 receives the plurality of bank information from the payment server 305. Further, while for convenience, it is the bank server 305 makes the determination that the bank information 601 is no longer valid, it could be determined by the electronic device 301, the bank server 307 or any combination of the payment server 305, the electronic device 301 and the bank server 307.

In operation 705, the electronic device 301 generates a new identifier from the received bank information. It will be understood that the new identifier may be generated when the bank information is received or when a new transaction is generated as in operation 403 of FIG. 4.

In operation 707, the electronic device 301 stores the received bank information and the generated new identifier on a storage of the electronic device.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents. Various embodiments of the present disclosure are described as examples only and are not intended to limit the scope of the present disclosure. Accordingly, the scope of the present disclosure should be understood as to include any and all modifications that may be made without departing from the technical spirit of the present disclosure.

What is claimed is:

1. A method for confirming bank information on an electronic device, the method comprising:
transmitting, to a payment server, a transactional message of a payment system, the transactional message including an identifier of the bank information; and
receiving, when it is determined that the identifier of the bank information is no longer valid, a plurality of bank information.

2. The method of claim 1, further comprising:
generating a new identifier from the received bank information; and
storing the received bank information and the generated new identifier.

3. The method of claim 2, wherein the generating of the new identifier is performed using a secure hash algorithm (SHA).

4. The method of claim 3, wherein the SHA is agreed upon by each of the electronic device and the payment server.

5. The method of claim 2, further comprising:
receiving bank card information to be used in future transactions of the payment system; and
determining based upon the stored received bank information whether the bank card information is valid.

6. The method of claim 5, wherein the bank information comprises bank identifier numbers (BINs).

7. The method of claim 6, wherein the BINs are used to determine a proper format of data entered for the bank card information.

8. An electronic device confirming bank information, the electronic device comprising:
a memory configured to store data and executable instructions;
a transceiver for transmitting and receiving the data; and
a processor configured by the executable instructions to:
transmit, to a payment server, a transactional message of a payment system, the transactional message including an identifier of the bank information, and
receive, when it is determined that the identifier of the bank information is no longer valid, a plurality of bank information.

9. The electronic device of claim 8, wherein the processor is further configured to:
generate a new identifier from the received bank information; and
store the received bank information and the generated new identifier.

10. The electronic device of claim 9, wherein, when the generation of the new identifier is performed, the processor is further configured to use secure hash algorithm (SHA) to generate the new identifier.

11. The electronic device of claim 10, wherein the SHA is agreed upon by each of the electronic device and the payment server.

12. The electronic device of claim 9, wherein the processor is further configured to:
receive bank card information to be used in future transactions of the payment system; and
determine based upon the stored received bank information whether the bank card information is valid.

13. The electronic device of claim 12, wherein the bank information comprises bank identifier numbers (BINs).

14. The electronic device of claim 13, wherein the BINs are used to determine a proper format of data entered for the bank card information.

15. A non-transitory computer readable storage medium with a computer program stored thereon, the computer program executed by a processor to perform a method for confirming bank information on an electronic device, the method comprising:
transmitting, to a payment server, a transactional message of a payment system, the transactional message including an identifier of the bank information; and
receiving, when it is determined that the identifier of the bank information is no longer valid, a plurality of bank information.

16. The non-transitory computer readable storage medium of claim 15, further comprising:
generating a new identifier from the received bank information; and
storing the received bank information and the generated new identifier.

17. The non-transitory computer readable storage medium of claim 16, wherein the generating of the new identifier is performed using a secure hash algorithm (SHA).

18. The non-transitory computer readable storage medium of claim 17, wherein the SHA is agreed upon by each of the electronic device and the payment server.

19. The non-transitory computer readable storage medium of claim 16, further comprising:
receiving bank card information to be used in future transactions of the payment system; and
determining based upon the stored received bank information whether the bank card information is valid.

20. The non-transitory computer readable storage medium of claim 19, wherein the bank information comprises bank identifier numbers (BINs).
